(19) United States
(12) Patent Application Publication
(10) Pub. No.: US 2012/0093369 A1
(43) Pub. Date: Apr. 19, 2012

(54) METHOD, TERMINAL DEVICE, AND COMPUTER-READABLE RECORDING MEDIUM FOR PROVIDING AUGMENTED REALITY USING INPUT IMAGE INPUTTED THROUGH TERMINAL DEVICE AND INFORMATION ASSOCIATED WITH SAME INPUT IMAGE

(75) Inventor: Jung Hee Ryu, Seoul (KR)

(73) Assignee: OLAWORKS, INC., Seoul (KR)

(21) Appl. No.: 13/378,213

(22) PCT Filed: Apr. 29, 2011
(86) PCT No.: PCT/KR2011/003205

§ 371 Date: Dec. 14, 2011

(30) Foreign Application Priority Data
Apr. 30, 2010 (KR) 10-2010-0040815

(51) Int. Cl. G06K 9/00

(52) U.S. Cl. 382/103

(57) ABSTRACT

The present invention relates to a method for providing augmented reality (AR) by using an image inputted to a terminal and information relating to the inputted image. The method includes the steps of: (a) acquiring recognition information on an object included in the image inputted through the terminal; (b) instructing to search detailed information on the recognized object and providing a tag accessible to the detailed information, if the searched detailed information is acquired, on a location of the object appearing on a screen of the terminal in a form of the augmented reality; and (c) displaying the detailed information corresponding to the tag, if the tag is selected, in the form of the augmented reality; wherein, at the step (b), the information on the location of the object is acquired by applying an image recognition process to the inputted image.

### FIELD OF THE INVENTION

The present invention relates to a method, a terminal and a computer-readable recording medium for providing augmented reality (AR) by using an image inputted to a terminal and information related to the inputted image; and more particularly, to the method, the terminal and the computer-readable recording medium for supporting a user to acquire information on a location of an object of interest and detailed information on the object of interest by recognizing the object included in the image inputted to the terminal, searching the detailed information on the recognized object, acquiring a tag accessible to the detailed information, showing the tag on the location of the object appearing on a screen of the terminal in a form of the augmented reality and displaying the detailed information if the user selects the tag.

### BACKGROUND OF THE INVENTION

As users have recently been able to acquire images easily by using cameras in a mobile environment thanks to the development of digital devices, studies on augmented reality are actively conducted.

Unlike a technology of virtual reality that excludes a reciprocal action from the real world and processes an action only in an already built virtual space, the augmented reality is a technology which allows a user to rapidly acquire information on an area, an object, etc. that the user is observing by displaying already acquired information on the real world based on a real time process overlappedly on an image of the real world inputted through the terminal to interact with the real world.

However, most conventional technologies that provide additional information on a surrounding environment or an object inputted through a screen of the terminal by using augmented reality commonly offer only information on a building or a place that a service provider has already designated. Accordingly, if the user wants to get additional information on other objects that the service provider has not designated, it is impossible for to acquire appropriate information.

### SUMMARY OF THE INVENTION

It is, therefore, an object of the present invention to solve all the problems mentioned above.

It is another object of the present invention to allow a user to recognize a location of an object of interest conveniently and access detailed information on the object of interest by displaying an icon for accessing the detailed information on the location of the object in an image inputted to a terminal in a form of augmented reality.

In accordance with one aspect of the present invention, there is provided a method for providing augmented reality (AR) by using an image inputted to a terminal and information relating to the inputted image, including the steps of: (a) acquiring recognition information on an object included in the image inputted through the terminal; (b) instructing to search detailed information on the recognized object and providing a tag accessible to the detailed information, if the searched detailed information is acquired, on a location of the object appearing on a screen of the terminal in a form of the augmented reality; and (c) displaying the detailed information corresponding to the tag, if the tag is selected, in the form of the augmented reality; wherein, at the step (b), the information on the location of the object is acquired by applying an image recognition process to the inputted image.

In accordance with one aspect of the present invention, there is provided a method for providing augmented reality (AR) by using an image inputted to a terminal and information relating to the inputted image, including the steps of: (a) acquiring a tag corresponding to an object included in the inputted image through the terminal; (b) providing the tag on a location of the object appearing on a screen of the terminal in a form of augmented reality; (c) instructing to search detailed information on the object by referring to recognition information on the object corresponding to the tag, if the tag is selected, and displaying the searched detailed information, if acquired, in the form of the augmented reality; wherein, at the step (b), information on the location of the object is acquired by applying an image recognition process to the inputted image.

In accordance with one aspect of the present invention, there is provided a terminal for providing augmented reality (AR) by using an image inputted thereto and information relating to the inputted image, including: a detailed information acquiring part for instructing to search detailed information by referring to information on a recognized object included in the image inputted thereto and acquiring the searched detailed information on the recognized object; a tag managing part for acquiring a tag accessible to the searched detailed information; a user interface part for providing the tag on a location of the object appearing on a screen thereof in a form of the augmented reality and displaying the detailed information corresponding to the tag if the tag is selected; and an object recognizing part for acquiring information on the location of the object by applying an image recognition process to the inputted image.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing briefly showing a configuration of an entire system to provide augmented reality by using an image inputted to a terminal and information relating to the inputted image in accordance with an example embodiment of the present invention.

FIG. 2 is a drawing exemplarily illustrating an internal configuration of the terminal 200 in accordance with an example embodiment of the present invention.

FIGS. 3A to 3D are diagrams exemplarily representing a course of recognizing an object included in an image inputted to the terminal 200, acquiring detailed information on the recognized object, displaying a tag accessible to the detailed information on a location of the object appearing on a screen of the terminal and displaying the detailed information corresponding to the tag in a form of augmented reality, if the user selects the tag.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a certain feature, structure, or characteristic described. herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows:

### Configuration of Entire System

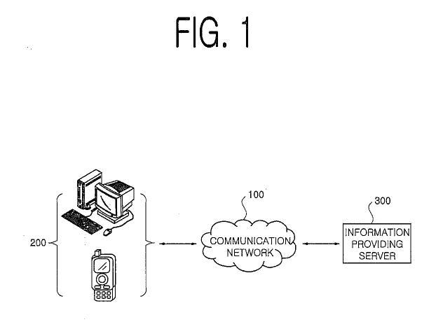

FIG. 1 is a drawing briefly showing a configuration of an entire system for providing augmented reality by using an image inputted to a terminal and information relating to the inputted image in accordance with an example embodiment of the present invention.

As illustrated in FIG. 1, the entire system in accordance with an example embodiment of the present invention may include a communication network 100, a terminal 200, and an information providing server 300.

First, the communication network 100 in accordance with an example embodiment of the present invention may be configured, regardless of wired or wireless, in a variety of networks, including a telecommunication network, a local area network (LAN), a metropolitan area network (MAN), a wide area network (WAN), an artificial satellite network, etc. More preferably, the communication network 100 in the present invention must be understood to be a concept of networks including the World Wide Web (www), CDMA (Code Division Multiple Access), WCDMA (Wideband Code Division Multiple Access) or GSM (Global System for Mobile Communications).

In addition, the terminal 200 in accordance with an example embodiment of the present invention may perform a function of receiving detailed information on an object included in an image inputted through a photographing instrument such as a camera (which must be understood to be a concept of including a mobile device with a camera) from the information providing server 300 to be explained later, displaying a tag in a form of an icon accessible to the detailed information on a location of the object appearing on a screen of the terminal 200 in a form of augmented reality and displaying the detailed information corresponding to the tag according to an act of the user to select the tag.

In accordance with the present invention, the terminal 200 may be a digital device capable of allowing the user to access to, and then communicate with, the communication network 100. Herein, the digital device, such as a personal computer (e.g., desktop, laptop, tablet PC, etc.), a workstation, a PDA, a web pad, and a cellular phone, which has a memory means and a micro processor with a calculation ability, may be adopted as the terminal 200 in accordance with the present invention. The internal configuration of the terminal 200 will be explained later.

In accordance with an example embodiment of the present invention, the information providing server 300 may perform a function of providing various kinds of information at a request of. the terminal 200 by communicating with the terminal 200 and another information providing server (non-illustrated) through the communication network 100. More specifically, the information providing server 300, which includes a web content search engine (non-illustrated), may search detailed information corresponding to the request of the terminal 200 and provide the search result to allow a user of the terminal 200 to browse. For example, the information providing server 300 may be an operating server of an Internet search portal and the information provided for the terminal 200 through the information providing server 300 may be various types of information, including information on the matching result in response to a queried image and information on websites, web documents, knowledge, blogs, communities, images, videos, news, music, shopping, maps, books, movies and the like. Of course, the search engine of the information providing server 300, if necessary, may be included in a different computing device or a recording medium.

### Configuration of Terminal

Below is an explanation on an internal configuration and components of the terminal 200 which perform their important functions for implementing the present invention.

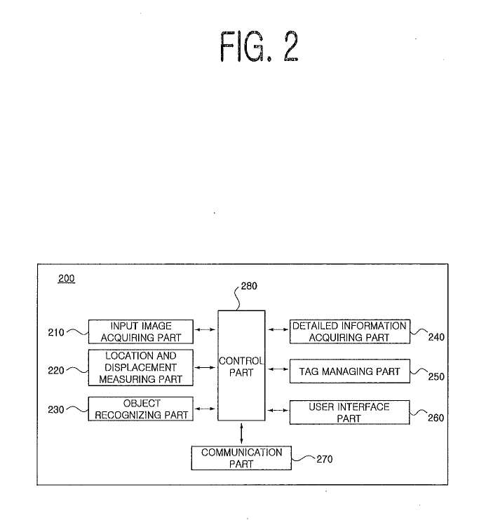

FIG. 2 exemplarily represents the internal configuration of the terminal 200 in accordance with an example embodiment of the present invention.

By referring to FIG. 2, the terminal 200 in accordance with an example embodiment of the present invention may include an input image acquiring part 210, a location and displacement measuring part 220, an object recognizing part 230, a detailed information acquiring part 240, a tag managing part 250, a user interface part 260, a communication part 270 and a control part 280. In accordance with an example embodiment of the present invention, at least some of the input image acquiring part 210, the location and displacement measuring part 220, the object recognizing part 230, the detailed information acquiring part 240, the tag managing part 250, the user interface part 260, the communication part 270 and the control part 280 may be program modules communicating with the user terminal 200. The program modules may be included in the terminal 200 in a form of an operating system, an application program module and other program modules and may also be stored on several memory devices physically. Furthermore, the program modules may be stored on remote memory devices communicable to the terminal 200. The program modules may include but not be subject to a routine, a subroutine, a program, an object, a component, and a data structure for executing a specific operation or a type of specific abstract data that will be described in accordance with the present invention.

In accordance with an example embodiment of the present invention, the input image acquiring part 210 may perform a function of acquiring an image inputted through the terminal 200 as a basis of augmented reality implemented by the user interface part 260, which will be explained later. More precisely, the input image acquiring part 210 in accordance with an example embodiment of the present invention may include a photographing instrument such as a camera and conduct a function of receiving landscape appearance around a user in real time in a state of preview.

To determine to which region of the real world the inputted image acquired by the terminal 200 corresponds, the location and displacement measuring part 220 in accordance with an example embodiment of the present invention may carry out a function of measuring a location and a displacement of the terminal 200.

More specifically, the location and displacement measuring part 220 in accordance with an example embodiment of the present invention may measure the location of the terminal 200 by using technologies for acquiring location information such as GPS (Global Positioning System) or mobile communications technologies [e.g., A-GPS (Assisted GPS) for using a network router or a wireless network base station and WPS (Wi-Fi Positioning System) for using information on an address of a wireless access point]. For example, the location and displacement measuring part 220 may include a GPS module or a mobile communications module.. In addition, the location and displacement measuring part 220 in accordance with an example embodiment of the present invention may measure the displacement of the terminal 200 by using a sensing means. For instance, the location and displacement measuring part 220 may include an accelerometer for sensing a moving distance, a velocity, a moving direction, etc. of the terminal 200, a digital compass for sensing an azimuth angle, and a gyroscope for sensing a rotation rate, an angular velocity, an angular acceleration, a direction, etc. of the terminal 200.

In addition, the location and displacement measuring part 220 in accordance with an example embodiment of the present invention may perform a function of specifying the visual field of the terminal 200 corresponding to the image inputted thereto, based on a visual point, i.e., a location of a lens of the terminal 200, by referring to information on the location, the displacement, and the view angle of the terminal 200 measured as shown above.

More specifically, the visual field of the terminal 200 in accordance with an example embodiment of the present invention means a three-dimensional region in the real world and it may be specified as a viewing frustum whose vertex corresponds to a visual point of the terminal 200. Herein, the viewing frustum indicates the three-dimensional region included in a visual field of a photographing instrument, such as a camera, if an image is taken by the photographing instrument or inputted in a preview state therethrough. It may be defined as an infinite region in a shape of a cone or a polypyramid according to types of photographing lenses (or as a finite region in a shape of a trapezoidal cylinder or a trapezoidal polyhedron created by cutting the cone or the polypyramid by a near plane or a far plane which is vertical to a visual direction, i.e., a direction of a center of the lens embedded in the terminal 200 facing the real world which is taken by the lens, the near plane being nearer to the visual point than the far plane) based on the center of the lens serving as the visual point. With respect to the viewing frustum, the specification of Korean Patent Application No. 2010-0002340 filed by the applicant of the present invention may be referred to. The specification must be considered to have been combined herein.

Next, the object recognizing part 230 in accordance with an example embodiment of the present invention may perform a function of recognizing an object by applying recognition technologies such as an object recognition technology, an audio recognition technology, and/or a character recognition technology to the object included in the inputted image in a state of preview through a screen of the terminal 200 and/or the object included in an audio element inputted with the inputted image.

Herein, as an object recognition technology for recognizing a specific object included at a variety of angles and distances in the inputted image, an article titled “A Comparison of Affine Region Detectors” co-authored by K. MIKOLAJCZYK and seven others and published in “International Journal of Computer Vision” in November 2005 may be referred to (The whole content of the article may be considered to have been combined herein). The article describes how to detect an affine invariant region to precisely recognize an identical object taken at a variety of angles. Of course, the object recognition technology applicable to the present invention is not limited only to the method described in the article and it will be able to reproduce the present invention by applying various examples.

In addition, as an audio recognition technology for recognizing an object from an audio element inputted with an inputted image, the specification of Korean Patent Application No. 2007-0107705 filed by the applicant of the present invention may be referred to. (The specification must be considered to have been combined herein). The specification describes how to create a result of voice recognition by dividing a word segment in a raw text corpus into morphemes and using the morpheme as a recognition unit. Of course, the audio recognition technology applicable to the present invention is not limited only to the method described in the specification and it will be able to reproduce the present invention by applying various examples including a sound recognition technology. For example, if some section of a specified song is inputted to the terminal 200, the object recognizing part 230 may recognize an object (i.e., a title, of a song) by using the voice recognition technology and/or the sound recognition technology and instruct the user interface part 260 to display a tag accessible to detailed information including the title of the song, etc. on the screen of the terminal 200 in a form of the augmented reality.

Furthermore, an optical character recognition (OCR) technology for recognizing a special string included in an inputted image, the specification of Korean Patent Application No. 2006-0078850 filed by the applicant of the present invention may be referred to. (The specification must be considered to have been combined herein). The specification describes a method for creating respective character candidates forming a string included in the inputted image and performing a character recognition process for the respective character candidates. Of course, the optical character recognition technology is not limited only to the method described in the specification and it will be able to reproduce the present invention by applying various examples.

The case of the object recognizing part 230 in the terminal 200 recognizing an object included in an inputted image is explained as an example but such a case is not limited only to this and even a case of the information providing server 300 or a separate server (non-illustrated) recognizing an object included in an inputted image after receiving information on the inputted image from the terminal 200 may be able to be applied. In the latter case, the terminal 200 will be able to receive an identity of the object from the information providing server 300 or the separate server.

During the course of recognizing the object by applying the aforementioned technologies, the object recognizing part 230 in accordance with an example embodiment of the present invention may i) recognize a location (i.e., a latitude, a longitude, and an altitude of the object) at which the object exists by detecting a current location of the terminal 200 in use of technologies for acquiring location information such as GPS technology, A-GPS technology, WPS technology or cell-based LBS (Location Based Service) and measuring a distance between the object and the terminal 200 and a direction of the object from the terminal 200 by using a distance measurement sensor, an accelerometer sensor and a digital compass; or ii) recognize the location of the object by performing an image recognition process in use of information acquired from street view, indoor scanning (e.g., scanning an interior structure, shape, etc. of an indoor place where the object, if any, exists), etc. for the inputted image acquired by the terminal 200. Herein, it will be able to reproduce the present invention by applying various examples.

In accordance with an example embodiment of the present invention, the detailed information acquiring part 240 may perform a function of delivering information on the object (e.g., a book) recognized by the information providing server 300 through the aforementioned processes to instruct the information providing server 300 to search the detailed information on the object (e.g., a bookstore which provides the book, price information, a name of an author of the book, etc.) and also a function of receiving the search result from the information providing server 300 if the information providing server 300 finishes searching after a certain amount of time.

Thereafter, the tag managing part 250 in accordance with an example embodiment of the present invention may select and decide a form of tag (e.g., a tag in a shape of icon such as a thumbnail) accessible to the detailed information on the object acquired by the detailed information acquiring part 240. For this, the tag selected by the tag managing part 250 may be set to have a correspondence with the detailed information on the object. Herein, the tag may be displayed in a form of so-called an actual image thumbnail or a basic thumbnail, where the actual image thumbnail means a thumbnail created by directly using the image of the object included in the inputted image and the basic thumbnail means a thumbnail created by using an image, stored on a database, that corresponds to the recognized object.

Furthermore, the user interface part 260 in accordance with an example embodiment of the present invention may offer a function of providing the inputted image acquired by the input image acquiring part 210 and the tag selected by the tag managing part 250 on the location of the object appearing on the screen of the terminal 200 in a form of augmented reality and displaying the detailed information acquired by the detailed information acquiring part 240, if the tag is selected by the user, in the form of augmented reality.

In addition, the user interface part 260 in accordance with an example embodiment of the present invention may conduct a function of displaying the tag in the form of the augmented reality even in other terminal devices in addition to the terminal which provides the inputted image and provide the detailed information on the object corresponding to the tag for a random user of a random terminal device in the form of the augmented reality, if selected by the random user of the random terminal device, to thereby lead multiple users to share the tag and the detailed information on the object.

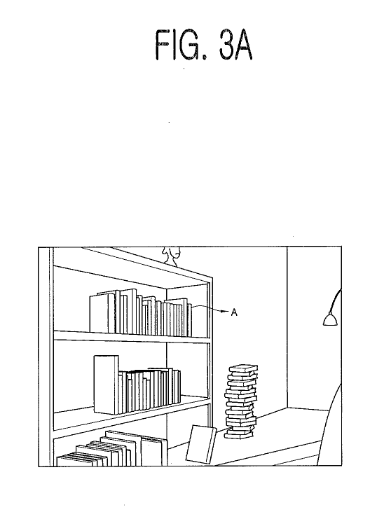

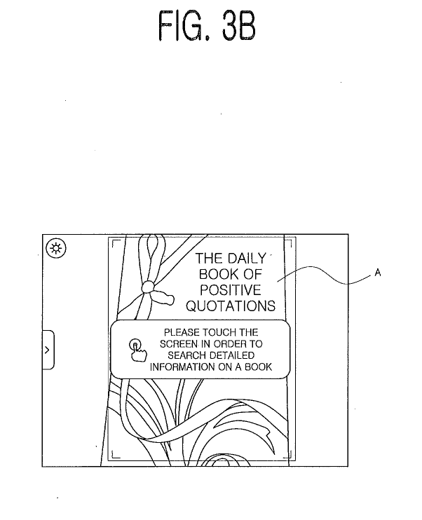

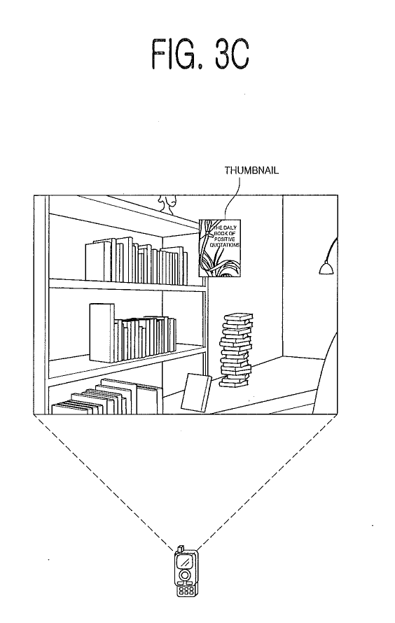

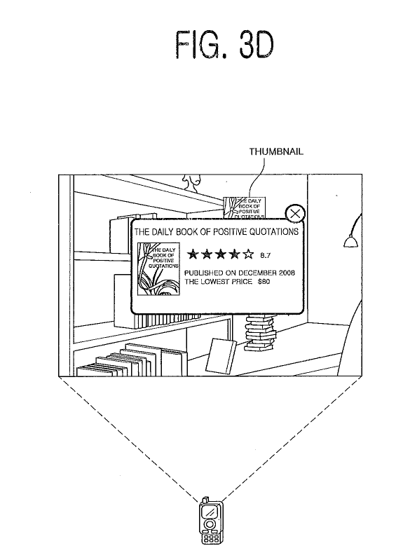

FIGS. 3A to 3D are diagrams exemplarily representing a course of recognizing an object included in an image inputted to the terminal 200, acquiring detailed information on the recognized object, displaying a tag accessible to the detailed information on the recognized object on a location of the recognized object appearing on a screen of the terminal and the detailed information corresponding to the tag in a form of the augmented reality, if the user selects the tag.

By referring to FIGS. 3A to 3D, a course of selecting and pulling a book A in a scene on which a variety of books are put on a specified bookshelf is illustrated (See FIG. 3A) and an example of acquiring an image of the book A by using a camera embedded in the terminal 200 is represented (See FIG. 3B). As such, if the image of the book A is inputted through the terminal 200, an object recognition technology and/or a character recognition technology may be applied to the image of the inputted book A and accordingly the book A included in the inputted image may be able to be recognized as a book titled “The Daily Book of Positive Quotations”. Then, a course of searching detailed information on the book titled “The Daily Book of Positive Quotations” inputted as a query and acquiring it may be followed. In the future, if the user visits a same place and looks at the same part of the specific bookshelf as shown in FIG. 3A through a screen of the camera, a tag (or a thumbnail) of the aforementioned book may be displayed on a position where a visual search has been performed as shown in FIG. 3C. At the time, if the tag is selected by the user, the detailed information on the book A, i.e., a title, a price, an author, etc. of the book, may be displayed (See FIG. 3D).

As previously explained is the process for recognizing the object included in the image inputted through the terminal 200, searching the detailed information on the recognized object, displaying a tag accessible to the searched detailed information on the location of the object appearing on the screen of the terminal in the form of the augmented reality, and providing the detailed information corresponding to the tag if selected by the user, but the process are not limited only to this. Another exemplary process for acquiring the tag corresponding to the object included in the inputted image, displaying the tag on the location of the object appearing on the screen of the terminal in the form of the augmented reality, searching the detailed information on the object by referring to the recognized information on the object corresponding to the tag, if the tag is selected, and displaying the searched detailed information in the form of the augmented reality may be able to be applied to reproduce the present invention.

In accordance with an example embodiment of the present invention, information on other images as well as the information on the output image implemented in the augmented reality, for example, may be visually expressed through a display part (non-illustrated) of the terminal 200. For example, the display part in accordance with an example embodiment of the present invention may be a flat-panel display including an LCD (Liquid Crystal Display) or an OLED (Organic Light Emitting Diodes).

In accordance with an example embodiment of the present invention, the communication part 270 may perform a function of allowing the terminal 200 to communicate with an external device such as the information providing server 300.

Lastly, the control part 280 in accordance with an example embodiment of the present invention may control the flow of the data among the input image acquiring part 210, the location and displacement measuring part 220, the object recognizing part 230, the detailed information acquiring part 240, the tag managing part 250, the user interface part 260, and the communication part 270. In other words, the control part 280 may control the flow of data from outside or among the components of the terminal 200 to thereby force the input image acquiring part 210, the location and displacement measuring part 220, the object recognizing part 230, the detailed information acquiring part 240, the tag managing part 250, the user interface part 260, and the communication part 270 to perform their unique functions.

In accordance with the present invention, since a tag accessible to the detailed information on the object included in the inputted image is displayed on the location of the object in a form of the augmented reality and the detailed information on the object is provided to the user if the tag is selected, the user may conveniently acquire the information on the location of the object of interest and the detailed information on the object.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

1. A method for providing augmented reality (AR) by using an image inputted to a terminal and information relating to the inputted image, comprising the steps of:
(a) acquiring recognition information on an object included in the image inputted through the terminal;
(b) requesting a search of detailed information on the recognized object and providing a tag on a location of the object appearing on a screen of the terminal in a form of the augmented reality when the requested detailed information is acquired; and
(c) displaying the detailed information corresponding to the tag, if the tag is selected, in the form of the augmented reality;
wherein, at the step (b), the information on the location of the object is acquired by applying an image recognition process to the inputted image.

2. The method of claim 1, wherein the recognition information is acquired if the terminal recognizes the object included in the inputted image.

3. The method of claim 1, wherein, if a server connected with the terminal through a network recognizes the object included in the inputted image received as a query from the terminal, the recognition information is acquired from the server.

4. The method of claim 1, wherein the tag is displayed in at least one of an actual image thumbnail form created by using an image of the object included in the inputted image or a basic thumbnail form created by using an image, stored on a database, corresponding to the recognized object.

5. The method of claim 1, wherein, at the step (a), the inputted image is an image inputted in a state of preview through the screen of the terminal.

6. The method of claim 1, wherein the step (a) further includes a step of acquiring the object from an audio element inputted to the terminal with the inputted image.

7. The method of claim 6, wherein, at the step (a), the object is recognized by using at least one of the following technologies: an object recognition technology, an audio recognition technology and a character recognition technology.

8. The method of claim 1, wherein, at the step (b), the information on the location of the object is additionally acquired by referring to information on the current location of the terminal, a distance between the object and the terminal, and a direction of the object from the terminal.

9. The method of claim 8, wherein, at the step (b), the information on the location of the object is acquired by detecting the current location of the terminal by using at least one of the following technologies for acquiring location information: GPS technology, A-GPS technology, cell-based LBS and by measuring the distance between the object and the terminal and the direction of the object from the terminal in use of at least one of a distance measurement sensor, an accelerometer sensor and a digital compass.

10. The method of claim 1, wherein, at the step (b), the image recognition process is performed by using information acquired from at least one a of street view or an indoor scanning for the inputted image.

11. The method of claim 1, wherein, at the step (b), the tag is displayed in the form of the augmented reality even on other terminals in addition to the terminal that provides the inputted image.

12. A method for providing augmented reality (AR) by using an image inputted to a terminal and information relating to the inputted image, comprising the steps of:
(a) acquiring a tag corresponding to an object included in the inputted image through the terminal;
(b) providing the tag on a location of the object appearing on a screen of the terminal in a form of augmented reality;
(c) requesting a search of detailed information on the object by referring to recognition information on the object corresponding to the tag, if the tag is selected, and displaying the searched detailed information, if acquired, in the form of the augmented reality;
wherein, at the step (b), information on the location of the object is acquired by applying an image recognition process to the inputted image.

13. A terminal for providing augmented reality (AR) by using an image inputted thereto and information relating to the inputted image, comprising:
a detailed information acquiring part for requesting a search of detailed information by referring to information on a recognized object included in the image inputted thereto and acquiring the searched detailed information on the recognized object;
a tag managing part for acquiring a tag accessible to the searched detailed information;
a user interface part for providing the tag on a location of the object appearing on a screen thereof in a form of the augmented reality and displaying the detailed information corresponding to the tag if the tag is selected; and
an object recognizing part for acquiring information on the location of the object by applying an image recognition process to the inputted image.

14. The terminal of claim 13, wherein the object recognizing part recognizes the object included in the inputted image.

15. The terminal of claim 14, wherein the object recognizing part additionally acquires the object from an audio element inputted thereto with the inputted image.

16. The terminal of claim 15, wherein the object recognizing part recognizes the object by using at least one of an object recognition technology, an audio recognition technology and a character recognition technology.

17. The terminal of claim 14, wherein the object recognizing part additionally acquires the information on the location of the object by referring to information on the current location thereof and a distance from the object thereto and a direction of the object therefrom.

18. The terminal of claim 17, wherein the object recognizing part acquires the information on the location of the object by detecting the current location of the terminal by using at least one of the following technologies for acquiring location information including: GPS technology, A-GPS technology, cell-based LBS and by measuring the distance from the object thereto and the direction of the object therefrom in use of at least one of a distance measurement sensor, an accelerometer sensor and a digital compass.

19. The terminal of claim 13, wherein the object recognizing part performs the image recognition process by using information acquired from at least one of a street view or an indoor scanning for the inputted image.

20. The terminal of claim 13, wherein the recognition information is acquired from a server connected therewith through a network after the server recognizes the object included in the inputted image received as a query.

21. The terminal of claim 13, wherein the user interface part displays the tag in at least one of an actual image thumbnail form created by using an image of the object included in the inputted image or a basic thumbnail form created by using an image, stored on a database, corresponding to the recognized object.

22. The terminal of claim 13, wherein the inputted image is an image inputted in a state of preview through the screen thereof.

23. A medium recording a computer readable program to execute the method of claim 1.
